(19) United States
(12) Patent Application Publication
(10) Pub. No.: US 2026/0125288 A1
(43) Pub. Date: May 7, 2026

(54) ADSORBENT MATERIAL FOR OILY WASTEWATER, AND PREPARATION METHOD AND USE THEREOF

(71) Applicant: Nanjing Tech University, Nanjing City (CN)

(72) Inventors: Zhouyang LIAN, Nanjing City (CN); Jie WANG, Nanjing City (CN); Ziyang FANG, Nanjing City (CN); Zhengwei LUO, Nanjing City (CN); Yan DU, Nanjing City (CN); Xueying ZHANG, Nanjing City (CN); Shengxiu MA, Nanjing City (CN); Guifang SHI, Nanjing City (CN); Qiang ZHOU, Nanjing City (CN); Xuejun WANG, Nanjing City (CN)

(21) Appl. No.: 19/071,946

(22) Filed: Mar. 6, 2025

(30) Foreign Application Priority Data
Nov. 5, 2024 (CN) 202411561905.6

(51) Int. Cl. C02F 1/28; C02F 101/32

(52) U.S. Cl. CPC C02F 1/288; C02F 1/285; C02F 2101/32

(57) ABSTRACT

An adsorbent material for oily wastewater, and a preparation method and use thereof are provided. The adsorbent material for the oily wastewater includes two or more adsorbent layers that are laminated; where water contact angles of the two or more adsorbent layers of the adsorbent material for the oily wastewater increase or decrease layer by layer along a thickness direction of the adsorbent material for the oily wastewater; each of the two or more adsorbent layers is a modified polypropylene (PP) fiber layer; and each of the two or more adsorbent layers is provided with staggered through holes.

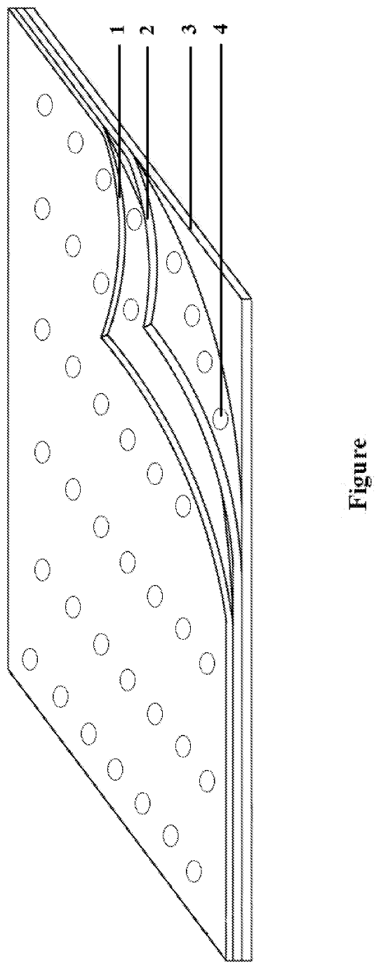

### CROSS REFERENCE TO RELATED APPLICATION

This patent application claims the benefit and priority of Chinese Patent Application No. 202411561905.6 filed with the China National Intellectual Property Administration on Nov. 5, 2024, the disclosure of which is incorporated by reference herein in its entirety as part of the present application.

### TECHNICAL FIELD

The present disclosure relates to the technical field of composites, and in particular to an adsorbent material for oily wastewater, and a preparation method and use thereof.

### BACKGROUND

Petroleum is one of the important energy sources for human survival and development. In the exploration, mining, refining, processing and transportation of the petroleum, a large amount of wastewater containing oily organic pollutants could inevitably be produced. The oily organic pollutants in the wastewater commonly include: one is animal fat and vegetable oil, which are composed of triglycerides formed by fatty acids or glycerol of different chain lengths; the other is a liquid component of crude oil or mineral oil. The crude oil is a mixture of hydrocarbons, that is, all hydrocarbons are composed of straight or branched chains with a ring structure. Such wastewater entering environment directly could cause serious damage to ecosystem. Currently, main methods for treating the wastewater containing the oily organic pollutants include gravity separation, air flotation, and adsorption. Although the gravity separation and the air flotation show certain treatment effects, they are mainly aimed at high-concentration oil organic pollutants, and have a large equipment footprint and high investment and operation costs. The adsorption plays an important role during wastewater treatment. Adsorption characteristics of an adsorbent material could effectively promote adsorbing, enriching, and removing pollutants to purify the wastewater.

At present, commonly used adsorbent materials for treating the wastewater containing the oily organic pollutants include oil absorbent felts, oil absorbent cottons, and oil absorbent ropes. However, these adsorbent materials have a desirable adsorption effect on pure oil or large-scale surface floating oil, but have an extremely poor effect on floating oil containing less oil, as well as wastewater containing dispersed, emulsified, and dissolved oil organic pollutants. Even the pure oil or the large-scale surface floating oil continues to decrease in concentration during the treatment, and traditional adsorbent materials are difficult to play an effective role at this time.

### SUMMARY

Objects of the present disclosure is to provide an adsorbent material for oily wastewater, and a preparation method and use thereof. In the present disclosure, the adsorbent material for the oily wastewater shows desirable treatment capabilities for oily organic pollutants in different states.

To achieve the above objects, the present disclosure provides the following technical solutions.

The present disclosure provides an adsorbent material for oily wastewater, including two or more adsorbent layers that are laminated; where water contact angles of the two or more adsorbent layers of the adsorbent material for the oily wastewater increase or decrease layer by layer along a thickness direction of the adsorbent material for the oily wastewater; each of the two or more adsorbent layers is a modified polypropylene (PP) fiber layer; and each of the two or more adsorbent layers is provided with staggered through holes.

In some embodiments, each of the two or more adsorbent layers has a thickness of independently 1 mm to 10 mm.

In some embodiments, the two or more adsorbent layers have a maximum water contact angle of 125° to 145° and a minimum water contact angle of 60° to 85°.

In some embodiments, a PP fiber in the modified PP fiber layer has a diameter of 1 μm to 5 μm.

In some embodiments, the adsorbent material for the oily wastewater includes a first adsorbent layer, a second adsorbent layer, and a third adsorbent layer that are laminated in sequence.

In some embodiments, the first adsorbent layer has a water contact angle of 125° to 145°, the second adsorbent layer has a water contact angle of 90° to 120°, and the third adsorbent layer has a water contact angle of 60° to 85°.

In some embodiments, each of the two or more adsorbent layers is connected by heating fusion or spot welding.

The present disclosure further provides a method for preparing the adsorbent material for the oily wastewater described in the above technical solutions, including the following steps:
(1) subjecting PP fiber layers to grafting modification respectively to obtain the adsorbent layers with different water contact angles; and providing the through holes in the adsorbent layers with the different water contact angles; and
(2) laminating the adsorbent layers with the different water contact angles obtained in step (1) in a manner that the water contact angles increase or decrease layer by layer, and then conducting fixed connection to obtain the adsorbent material for the oily wastewater.

In some embodiments, the grafting modification in step (1) includes one or more selected from the group consisting of solution grafting, suspension grafting, plasma grafting, and blending modification.

The present disclosure further provides use of the adsorbent material for the oily wastewater described in the above technical solutions or the adsorbent material for the oily wastewater prepared by the method described in the above technical solutions in treating wastewater containing oily organic pollutants.

The present disclosure provides an adsorbent material for oily wastewater, including two or more adsorbent layers that are laminated; where water contact angles of the two or more adsorbent layers of the adsorbent material for the oily wastewater increase or decrease layer by layer along a thickness direction of the adsorbent material for the oily wastewater; each of the two or more adsorbent layers is a modified polypropylene (PP) fiber layer; and each of the two or more adsorbent layers is provided with staggered through holes. In the present disclosure, each of the adsorbent layers in the adsorbent material for the oily wastewater is the modified PP fiber layer, which has a certain oil adsorption performance and could improve the adsorption capacity of the oily wastewater. The water contact angles of the adsorbent material for the oily wastewater increase or decrease layer by layer. When treating wastewater, the oily wastewater contacts a side with a maximum water contact angle of the adsorbent material for the oily wastewater. When passing through the adsorbent material for the oily wastewater, the water contact angle of each of the adsorbent layers decreases successively, strengthening collision between oily organic pollutants and a oil adsorbent layer. In this way, low-concentration oily organic pollutants such as floating oil on a surface of the wastewater are re-adsorbed and removed, and an adsorption capacity of the oily organic pollutants is improved. By setting the staggered through holes in the adsorbent layers, treated wastewater could pass through the adsorbent layers in sequence. Results of examples show that the adsorbent material for the oily wastewater can be used to adsorb wastewater containing oily organic pollutants. After the wastewater containing the oily organic pollutants with a concentration of 420 mg/L is adsorbed by a first adsorbent layer, a second adsorbent layer, and a third adsorbent layer in sequence, the concentration is reduced to 5 mg/L, indicating that the adsorbent material for the oily wastewater has a desirable oil removal ability for wastewater containing organic pollutants with low oil content.

### BRIEF DESCRIPTION OF THE DRAWINGS

Figure shows a schematic diagram of the adsorbent material for the oily wastewater provided in an embodiment of the present disclosure.

### DETAILED DESCRIPTION OF THE EMBODIMENTS

The present disclosure provides an adsorbent material for oily wastewater, including two or more adsorbent layers that are laminated; where water contact angles of the two or more adsorbent layers of the adsorbent material for the oily wastewater increase or decrease layer by layer along a thickness direction of the adsorbent material for the oily wastewater; each of the two or more adsorbent layers is a modified polypropylene (PP) fiber layer; and each of the two or more adsorbent layers is provided with staggered through holes.

In the present disclosure, the adsorbent material for the oily wastewater includes two or more adsorbent layers that are laminated.

In the present disclosure, water contact angles of the two or more adsorbent layers of the adsorbent material for the oily wastewater increase or decrease layer by layer along a thickness direction of the adsorbent material for the oily wastewater. In the present disclosure, the water contact angles of the adsorbent material for the oily wastewater increase or decrease layer by layer. When treating wastewater, the oily wastewater contacts a side with a maximum water contact angle of the adsorbent material for the oily wastewater. When passing through the adsorbent material for the oily wastewater, the water contact angle of each of the adsorbent layers decreases successively, strengthening collision between oily organic pollutants and a oil adsorbent layer. In this way, low-concentration oily organic pollutants such as floating oil on a surface of the wastewater are re-adsorbed and removed, and an adsorption capacity of the oily organic pollutants is improved.

In some embodiments of the present disclosure, the two or more adsorbent layers have a maximum water contact angle of 125° to 145°, and preferably 132° to 140°. In some embodiments of the present disclosure, the two or more adsorbent layers have a minimum water contact angle of 60° to 85°, and preferably 68° to 77°. Controlling the maximum water contact angle and the minimum water contact angle of the adsorbent layers within the above ranges is more conducive to improving treatment capacity of wastewater containing oily organic pollutants.

In some embodiments of the present disclosure, the adsorbent layer of the adsorbent material for the oily wastewater is composed of three layers, and preferably includes a first adsorbent layer, a second adsorbent layer, and a third adsorbent layer that are laminated in sequence. In some embodiments of the present disclosure, the first adsorbent layer has a water contact angle of 125° to 145°, and preferably 132° to 140°. In some embodiments of the present disclosure, the second adsorbent layer has a water contact angle of 90° to 120°, and preferably 102° to 109°. In some embodiments of the present disclosure, the third adsorbent layer has a water contact angle of 60° to 85°, and preferably 68° to 77°. In the present disclosure, In the present disclosure, by adopting the above adsorbent material for the oily wastewater, the efficient treatment of wastewater containing organic pollutants with low oil content could be realized.

In the present disclosure, each of the two or more adsorbent layers is a modified PP fiber layer. In the present disclosure, the modified PP fiber layer is used as the adsorbent layers, which has an ability to adsorb oil-containing organic matters and could improve the treatment capacity of the adsorbent material for the oily wastewater on the wastewater containing the oily organic pollutants.

In some embodiments of the present disclosure, a PP fiber in the modified PP fiber layer has a diameter of 1 μm to 5 μm, and preferably 2 μm to 4 μm. In the present disclosure, the PP fiber of the above diameter enables the adsorbent layer to have a larger specific surface area.

In some embodiments of the present disclosure, each of the two or more adsorbent layers has a thickness of independently 1 mm to 10 mm, and preferably 5 mm to 8 mm. In the present disclosure, the adsorbent layer of the above thickness is more conducive to improving the treatment capacity of the wastewater containing the oily organic pollutants.

In the present disclosure, each of the two or more adsorbent layers is provided with staggered through holes. In the present disclosure, the staggered through holes are provided on each of the adsorbent layers such that adsorbed wastewater containing oily pollutants could be led from one adsorbent layer to the next adsorbent layer. In the present disclosure, the through holes are used for drainage, such that there is no special limitation on density, diameter, and number of the through holes. The through holes in different layers could be staggered by adjusting the size of each of the adsorbent layers and the efficiency of wastewater treatment required. In the embodiments, each of the adsorbent layers is provided with the through holes which are arranged equidistantly and opened in a staggered manner. The through holes in each of the adsorbent layers have a density of 1000 holes/m², adjacent through holes in each of the adsorbent layers may be spaced 3 cm apart, and the through hole may have a diameter of 2 mm.

In the present disclosure, each of the two or more adsorbent layers is connected by heating fusion or spot welding. In the present disclosure, by adopting the above method, each of the adsorbent layers could be fixedly connected to improve the stability during use.

In some embodiments of the present disclosure, Figure shows a schematic diagram of the adsorbent material for the oily wastewater provided in an embodiment of the present disclosure. In Figure, 1 refers to the first adsorbent layer; 2 refers to the second adsorbent layer; 3 refers to the third adsorbent layer; and 4 refers to the through hole.

The present disclosure further provides a method for preparing the adsorbent material for the oily wastewater described in the above technical solutions, including the following steps:
(1) subjecting PP fiber layers to grafting modification respectively to obtain the adsorbent layers with different water contact angles; and providing the through holes in the adsorbent layers with the different water contact angles; and
(2) laminating the adsorbent layers with the different water contact angles obtained in step (1) in a manner that the water contact angles increase or decrease layer by layer, and then conducting fixed connection to obtain the adsorbent material for the oily wastewater.

In the present disclosure, PP fiber layers are subjected to grafting modification respectively to obtain the adsorbent layers with different water contact angles; and the through holes are provided in the adsorbent layers with the different water contact angles.

In the present disclosure, there is no special limitation on a source of the PP fiber layer. The PP fiber layer is formed by interweaving conventional PP fibers with a diameter of 1 μm to 5 μm, such that a thickness of the PP fiber layer could reach 1 mm to 10 mm. In some embodiments of the present disclosure, the PP fiber layer is made of PP-based meltblown fibers.

In some embodiments of the present disclosure, the grafting modification is one or more selected from the group consisting of solution grafting, suspension grafting, plasma grafting, and blending modification. In the present disclosure, the grafting modification could graft different groups onto the PP fiber layers, such that each of the modified PP fiber layers has different hydrophobicity and exhibits different water contact angles. In some embodiments of the present disclosure, the group is at least one selected from the group consisting of a hydroxyl group, a carboxyl group, a sulfonic acid group, an amino group, a silane group, and a fluoroalkyl group.

In the present disclosure, there is no special limitation on process and specific parameters of the solution grafting, suspension grafting, plasma grafting, and blending modification. Conventional processes and parameters of the solution grafting, the suspension grafting, the plasma grafting, and the blending modification could be adjusted to enable the water contact angle of the adsorbent layer to reach the desired range.

In the present disclosure, the adsorbent layers with the different water contact angles are laminated in a manner that the water contact angles increase or decrease layer by layer, and then fixed connection is conducted to obtain the adsorbent material for the oily wastewater.

In some embodiments of the present disclosure, a method of fixed connection is heating fusion or spot welding. There is no special limitation on a method of the heating fusion or the spot welding, and conventional operation methods of the heating fusion or the spot welding may be used to achieve fixed connection of each of the adsorbent layers.

In the present disclosure, the method has advantages of simple operation and could obtain the adsorbent material for the oily wastewater having desirable treatment capability for the wastewater containing the oily organic pollutants.

The present disclosure further provides use of the adsorbent material for the oily wastewater described in the above technical solutions in treating wastewater containing oily organic pollutants.

In the present disclosure, there is no special limitation on a method of using the adsorbent material for the oily wastewater in treating the wastewater containing the oily organic pollutants, and a method of using conventional adsorbent materials to adsorb wastewater may be used. In some embodiments of the present disclosure, the method for using the adsorbent material for the oily wastewater in treating the wastewater containing the oily organic pollutants is to filter the wastewater using the adsorbent material for the oily wastewater; during filtration, the adsorbent layer with the maximum water contact angle contacts the wastewater.

In the present disclosure, there is no special limitation on a source of the wastewater containing the oily organic pollutants, and any conventional wastewater containing oily organic pollutants could be treated. In some embodiments of the present disclosure, the wastewater containing the oily organic pollutants is wastewater from the petrochemical industry. In some embodiments of the present disclosure, the wastewater containing the oily organic pollutants has an oil content of 200 mg/mL to 500 mg/L, and preferably 220 mg/mL to 420 mg/L. The wastewater containing the oily organic pollutants has the oil content within the above range and belongs to the wastewater containing the oily organic pollutants with a relatively low oil content. Since the adsorbent material for the oily wastewater provided could strengthen the collision between pollutants and an oil adsorbent layer as the water contact angle of each of the adsorbent layers gradually decreases when the wastewater passes through the adsorbent material, low-concentration oil organic pollutants such as floating oil on a surface of the wastewater could be re-adsorbed and removed.

The technical solutions of the present disclosure will be clearly and completely described below with reference to examples of the present disclosure. Apparently, the described examples are merely a part rather than all of the embodiments of the present disclosure. All other embodiments obtained by those skilled in the art based on the embodiments of the present disclosure without creative efforts shall fall within the scope of the present disclosure.

### Example 1

An adsorbent material for oily wastewater was composed of three adsorbent layers that were laminated. Along a thickness direction of the adsorbent material for the oily wastewater, the adsorbent material for the oily wastewater was composed of a first adsorbent layer, a second adsorbent layer, and a third adsorbent layer that were laminated. The first adsorbent layer had a water contact angle of 140°, the second adsorbent layer had a water contact angle of 102°, and the third adsorbent layer had a water contact angle of 77°. Each of the adsorbent layers had a thickness of 5 mm. Each of the adsorbent layers was made of a modified PP fiber layer, and a PP fiber in the modified PP fiber layer had a diameter of 1 μm to 5 μm. Each of the adsorbent layers was provided with the small through holes which were arranged equidistantly and opened in a staggered manner. Adjacent through holes in each of the adsorbent layers were spaced 3 cm apart, and the through holes each had a diameter of 2 mm.

A method for preparing the adsorbent material for the oily wastewater was performed by the following steps.
(1) A PP substrate was grafted with silane groups by plasma grafting to obtain a first adsorbent layer made of PP-based meltblown fibers having a water contact angle of 140°. The plasma grafting was performed by the following steps: PP meltblown fibers were surface-activated at a plasma atmosphere pressure of 30 Pa, a discharge power of 15 W, and a discharge time of 5 minutes, and then the first adsorbent layer was obtained by grafting at a reaction temperature of 50° C. and a silane monomer concentration of 10% for 3 h, where through holes were provided.

A PP substrate was grafted with carboxyl groups by plasma grafting to obtain a second adsorbent layer made of PP-based meltblown fibers having a water contact angle of 102°. The plasma grafting was performed by the following steps: PP meltblown fibers were surface-activated at a plasma atmosphere pressure of 20 Pa, a discharge power of 15 W, and a discharge time of 3 minutes, and then the second adsorbent layer was obtained by grafting at a reaction temperature of 60° C. and a carboxyl monomer concentration of 30% for 4 h, where through holes were provided.

A PP substrate was grafted with sulfonic acid groups by solution grafting to obtain a third adsorbent layer made of PP-based meltblown fibers having a water contact angle of 77°. The solution grafting was performed by the following steps: a certain amount of PP was added with 2.5 mL/g of xylene and 8 wt % of 2,5-dimethyl-2,5-bis-hexane, and the grafting was conducted at 140° C. for 55 minutes at a sulfonic acid monomer concentration of 20%, and then melt-blowing spinning was conducted to obtain the PP-based meltblown fibers, which was the third adsorption layer, where through holes were provided.
(2) The first adsorbent layer, the second adsorbent layer, and the third adsorbent layer obtained in step (1) were laminated in order from top to bottom, and then subjected to fixed connection by heating fusion to obtain the adsorbent material for the oily wastewater.

### Example 2

An adsorbent material for oily wastewater was composed of three adsorbent layers that were laminated. Along a thickness direction of the adsorbent material for the oily wastewater, the adsorbent material for the oily wastewater was composed of a first adsorbent layer, a second adsorbent layer, and a third adsorbent layer that were laminated. The first adsorbent layer had a water contact angle of 132°, the second adsorbent layer had a water contact angle of 109°, and the third adsorbent layer had a water contact angle of 68°. Each of the adsorbent layers had a thickness of 8 mm. Each of the adsorbent layers was made of a modified PP fiber layer, and a PP fiber in the modified PP fiber layer had a diameter of 1 μm to 5 μm. Each of the adsorbent layers was provided with small through holes which were arranged equidistantly and opened in a staggered manner. Adjacent through holes in each of the adsorbent layers were spaced 3 cm apart, and the through holes each had a diameter of 2 mm.

A method for preparing the adsorbent material for the oily wastewater was performed by the following steps.
(1) A PP substrate was grafted with fluoroalkyl groups by blending modification to obtain a first adsorbent layer made of PP-based meltblown fibers having a water contact angle of 132°. The blending modification was performed by the following steps: PP and 30 wt % of fluorinated alkyl monomer were uniformly mixed, blended and modified in a twin-screw extruder, where temperatures of each section of the extruder were 140° C., 170° C., 170° C., and 130° C., and then melt-blowing spinning was conducted to obtain the PP-based meltblown fibers, which were the first adsorbent layer, where through holes were provided.

A PP substrate was grafted with hydroxyl groups by suspension grafting to obtain a second adsorbent layer made of PP-based meltblown fibers having a water contact angle of 109°. The suspension grafting was performed by the following steps: a certain amount of PP was added with 5 mL/g of deionized water, 10 wt % of xylene, and 0.4 wt % of benzoyl peroxide, and the grafting was conducted at 90° C. for 3 hours at a hydroxyl monomer concentration of 40%, and then melt-blowing spinning was conducted to obtain the PP-based meltblown fibers, which was the second adsorption layer, where through holes were provided.

A PP substrate was grafted with carboxyl and amino groups by suspension grafting to obtain a third adsorbent layer made of PP-based meltblown fibers having a water contact angle of 68°. The suspension grafting was performed by the following steps: a certain amount of PP was added with 2 mL/g of deionized water, 12 wt % of xylene, and 1 wt % of benzoyl peroxide, and the grafting was conducted at 90° C. for 3 hours at a carboxyl monomer concentration of 50% to obtain a resulting grafted product, dicyclohexylcarbodiimide and 1-hydroxybenzotriazole were used as condensation reagents, the resulting grafted product was subjected to reaction with an amino-containing monomer for 1 h, and melt-blowing spinning was conducted to obtain the PP-based meltblown fibers, which was the third adsorption layer, where through holes were provided.
(2) The first adsorbent layer, the second adsorbent layer, and the third adsorbent layer obtained in step (1) were laminated in order from top to bottom, and then subjected to fixed connection by heating fusion to obtain the adsorbent material for the oily wastewater.

### Comparative Example 1

A composite adsorbent material for wastewater containing oily organic pollutants was provided, where a PP substrate was grafted with fluoroalkyl groups by blending modification to obtain a first adsorbent layer made of PP-based meltblown fibers with a water contact angle of 132°, and materials of a second adsorbent layer and a third adsorbent layer were the same as those of the first adsorbent layer. Surfaces of the first adsorbent layer and the second adsorbent layer were both provided with small through holes which were arranged equidistantly and opened in a staggered manner. Adjacent through holes in each of the adsorbent layers were spaced 3 cm apart, and the through holes each had a diameter of 2 mm. The adsorbent layers were connected by spot welding to obtain the composite adsorbent material.

### Comparative Example 2

A composite adsorbent material for wastewater containing oily organic pollutants was provided, where a PP substrate was grafted with fluoroalkyl groups by blending modification to obtain a first adsorbent layer made of PP-based meltblown fibers with a water contact angle of 132°, the PP substrate was grafted with hydroxyl groups by suspension grafting to obtain a second adsorbent layer made of PP-based meltblown fibers with a water contact angle of 109°, and material of a third adsorbent layer was the same as that of the second adsorbent layer. Surfaces of the first adsorbent layer and the second adsorbent layer were both provided with small through holes which were arranged equidistantly and opened in a staggered manner. Adjacent through holes in each of the adsorbent layers were spaced 3 cm apart, and the through holes each had a diameter of 2 mm The adsorbent layers were connected by spot welding to obtain the composite adsorbent material.

### Use Example 1

The adsorbent material for the oily wastewater prepared in Example 1 was used to filter wastewater containing oily organic pollutants at a concentration of 420 mg/L. After the wastewater containing the oily organic pollutants was adsorbed by the first adsorbent layer, the second adsorbent layer, and the third adsorbent layer in sequence, the concentration of the oily organic pollutants measured was reduced to 5 mg/L.

### Use Example 2

The adsorbent material for the oily wastewater prepared in Example 2 was used to filter wastewater containing oily organic pollutants at a concentration of 220 mg/L. After the wastewater containing the oily organic pollutants was adsorbed by the first adsorbent layer, the second adsorbent layer, and the third adsorbent layer in sequence, the concentration of the oily organic pollutants measured was reduced to 3 mg/L.

### Comparative Use Example 1

The composite adsorbent material prepared in Comparative Example 1 was used to filter wastewater containing oily organic pollutants at a concentration of 220 mg/L. After the wastewater containing the oily organic pollutants was adsorbed by the first adsorbent layer, the second adsorbent layer, and the third adsorbent layer in sequence, the concentration of the oily organic pollutants measured was reduced to 40 mg/L.

### Comparative Use Example 2

The composite adsorbent material prepared in Comparative Example 2 was used to filter wastewater containing oily organic pollutants at a concentration of 220 mg/L. After the wastewater containing the oily organic pollutants was adsorbed by the first adsorbent layer, the second adsorbent layer, and the third adsorbent layer in sequence, the concentration of the oily organic pollutants measured was reduced to 18 mg/L.

It can be seen from the above results that an adsorbent material for oily wastewater provided by the present disclosure has excellent removal ability when treating wastewater containing oily organic pollutants with low oil content. This is because: when the wastewater containing the oily organic pollutants passes through a first adsorbent layer, a concentration of the oily organic pollutants in the wastewater is the highest at this time. When PP-based meltblown fibers with a large water contact angle, i.e., excellent lipophilic and hydrophobic properties, are selected as an adsorbent material of the first adsorbent layer, an adsorption amount of the oily organic pollutants and the adsorption speed are both high. Adsorbed wastewater mainly enters a second adsorbent layer through through holes, and a small part of the wastewater enters the second adsorbent layer through osmosis. At this time, the concentration of the oily organic pollutants in the wastewater is reduced, and PP-based meltblown fibers with a slightly lower water contact angle, i.e., desirable lipophilic properties but weakened hydrophobic properties, are selected as an adsorbent material of the second adsorbent layer. Strengthening the collision between the pollutants and oil adsorbent layers could re-adsorb and remove low-concentration oily organic pollutants such as floating oil on a surface of the wastewater. Adsorbed wastewater mainly enters a third adsorbent layer through through holes, and a small part of the wastewater enters the third adsorbent layer through osmosis. Then, PP-based meltblown fibers with a smaller water contact angle, i.e., reduced lipophilic properties but increased hydrophilic properties, are selected as an adsorbent material of the third adsorbent layer. At this time, the wastewater mainly contained extremely low concentrations of the oily organic pollutants in the form of dispersion, emulsification, and dissolution. Improving the hydrophilicity of the adsorbent material could further enhance collision adsorption effect between the pollutants and the oil adsorbent layers, thus finally adsorbing and removing the “oil-in-water” type of the oily organic pollutants. Therefore, in the adsorbent material for the oily wastewater provided by the present disclosure, the adsorbent layers with different water contact angles and different hydrophilic and lipophilic properties are provided to effectively adapt to hydrophilic and lipophilic properties of the adsorbent material required due to the change in the concentration of the oily organic pollutant in the wastewater, thereby greatly improving an adsorption and removal effect of the oily organic pollutants in different concentrations and states.

The above descriptions are merely preferred embodiments of the present disclosure. It should be noted that a person of ordinary skill in the art may further make several improvements and modifications without departing from the principle of the present disclosure, but such improvements and modifications should also be deemed as falling within the scope of the present disclosure.

What is claimed is:

1. An adsorbent material for oily wastewater, comprising two or more adsorbent layers that are laminated; wherein
water contact angles of the two or more adsorbent layers of the adsorbent material for the oily wastewater increase or decrease layer by layer along a thickness direction of the adsorbent material for the oily wastewater;
each of the two or more adsorbent layers is a modified polypropylene (PP) fiber layer; and
each of the two or more adsorbent layers is provided with staggered through holes.

2. The adsorbent material for the oily wastewater of claim 1, wherein each of the two or more adsorbent layers has a thickness of independently 1 mm to 10 mm.

3. The adsorbent material for the oily wastewater of claim 1, wherein the two or more adsorbent layers have a maximum water contact angle of 125° to 145° and a minimum water contact angle of 60° to 85°.

4. The adsorbent material for the oily wastewater of claim 1, wherein a PP fiber in the modified PP fiber layer has a diameter of 1 μm to 5 μm.

5. The adsorbent material for the oily wastewater of claim 1, wherein the adsorbent material for the oily wastewater comprises a first adsorbent layer, a second adsorbent layer, and a third adsorbent layer that are laminated in sequence.

6. The adsorbent material for the oily wastewater of claim 5, wherein the first adsorbent layer has a water contact angle of 125° to 145°, the second adsorbent layer has a water contact angle of 90° to 120°, and the third adsorbent layer has a water contact angle of 60° to 85°.

7. The adsorbent material for the oily wastewater of claim 1, wherein each of the two or more adsorbent layers is connected by heating fusion or spot welding.

8. A method for preparing the adsorbent material for the oily wastewater of claim 1, comprising the following steps:
(1) subjecting PP fiber layers to grafting modification respectively to obtain the adsorbent layers with different water contact angles; and providing the through holes in the adsorbent layers with the different water contact angles; and
(2) laminating the adsorbent layers with the different water contact angles obtained in step (1) in a manner that the water contact angles increase or decrease layer by layer, and then conducting fixed connection to obtain the adsorbent material for the oily wastewater.

9. The method of claim 8, wherein the grafting modification in step (1) comprises one or more selected from the group consisting of solution grafting, suspension grafting, plasma grafting, and blending modification.

10. A method of using the adsorbent material for the oily wastewater of claim 1, comprising using the adsorbent material for the oily wastewater in treating wastewater containing oily organic pollutants.

11. The method of claim 8, wherein each of the two or more adsorbent layers has a thickness of independently 1 mm to 10 mm.

12. The method of claim 8, wherein the two or more adsorbent layers have a maximum water contact angle of 125° to 145° and a minimum water contact angle of 60° to 85°.

13. The method of claim 8, wherein a PP fiber in the modified PP fiber layer has a diameter of 1 μm to 5 μm.

14. The method of claim 8, wherein the adsorbent material for the oily wastewater comprises a first adsorbent layer, a second adsorbent layer, and a third adsorbent layer that are laminated in sequence.

15. The method of claim 14, wherein the first adsorbent layer has a water contact angle of 125° to 145°, the second adsorbent layer has a water contact angle of 90° to 120°, and the third adsorbent layer has a water contact angle of 60° to 85°.

16. The method of claim 8, wherein each of the two or more adsorbent layers is connected by heating fusion or spot welding.

17. The method of claim 10, wherein each of the two or more adsorbent layers has a thickness of independently 1 mm to 10 mm.

18. The method of claim 10, wherein the two or more adsorbent layers have a maximum water contact angle of 125° to 145° and a minimum water contact angle of 60° to 85°.

19. The method of claim 10, wherein a PP fiber in the modified PP fiber layer has a diameter of 1 μm to 5 μm.

20. The method of claim 10, wherein the adsorbent material for the oily wastewater comprises a first adsorbent layer, a second adsorbent layer, and a third adsorbent layer that are laminated in sequence.
